(19) United States
(12) Patent Application Publication
(10) Pub. No.: US 2021/0008906 A1
(43) Pub. Date: Jan. 14, 2021

(54) CUTTER DEVICE AND PRINTING APPARATUS

(71) Applicant: SEIKO EPSON CORPORATION, Tokyo (JP)

(72) Inventors: Koji YAMADA, Okaya-shi (JP); Hiroaki SAKAJO, Matsumoto-shi (JP)

(21) Appl. No.: 16/925,571

(22) Filed: Jul. 10, 2020

(30) Foreign Application Priority Data
Jul. 11, 2019 (JP) 2019-129019

(51) Int. Cl. B41J 11/70; B26D 1/18

(52) U.S. Cl. CPC B41J 11/706; B26D 1/185

(57) ABSTRACT

A cutter device includes a fixed blade extending in a first direction, a fixed shaft extending in a second direction intersecting the first direction, a round blade that is rotatably supported by the fixed shaft, comes into contact with the fixed blade and moves in the first direction while rotating, and an urging portion that presses the round blade in the second direction along the fixed shaft. A load of the round blade pressing the fixed blade is at least 300 gf, a diameter of the round blade is at least 20 mm, and D/L is not greater than 2.0, where the diameter of the round blade is D and a length over which the fixed shaft supports the round blade is L.

The present application is based on, and claims priority from JP Application Serial Number 2019-129019, filed Jul. 11, 2019, the disclosure of which is hereby incorporated by reference herein in its entirety.

### BACKGROUND

### 1. Technical Field

The disclosure relates to a cutter device and a printing apparatus.

### 2. Related Art

In related art, a cutter device is known that is built into a printing apparatus and the like, and that cuts a printed continuous sheet. JP-A-2011-235428 discloses a cutter device using a round blade as a movable blade. When the cutter device is mounted on a label printer, which is an example of the printing apparatus, and performs cutting of a label sheet, an adhesive interposed between the label and a backing adheres to a round blade, and when the cutting is performed a number of times, the adhered adhesive accumulates on the round blade, increases, and eventually causes a cutting defect. In terms of the configuration of the cutter device and the label printer, when it is difficult to dismantle and clean the round blade, it is necessary to replace the cutter device when the accumulation of the adhesive on the round blade progresses and a failure in cutting the label sheet occurs.

In order to increase the lifespan of the cutter device over which the replacement is not necessary, it is conceivable to increase a diameter of the round blade in order to increase an allowable amount of the adhesive that can accumulate on the round blade. However, simply increasing the diameter of the round blade increases the diameter of the round blade relative to the length of a fixed shaft that fixes the round blade, and as a result, a gouging force that bears on the fixed shaft when the round blade rotates is increased and inhibits the rotation of the round blade, which may result in cutting defects. In other words, it is difficult to achieve both an extended lifespan of the cutter device and a suppression of cutting defects.

### SUMMARY

A cutter device includes a fixed blade extending in a first direction, a fixed shaft extending in a second direction intersecting the first direction, a round blade rotatably supported by the fixed shaft and configured to come into contact with the fixed blade positioned in the second direction and to move in the first direction while rotating, and an urging portion configured to press the round blade in the second direction along the fixed shaft. A load of the round blade pressing the fixed blade is at least 300 gf, a diameter of the round blade is at least 20 mm, and D/L is not greater than 2.0, where the diameter of the round blade is D and a length over which the fixed shaft supports the round blade is L.

In the cutter device described above, where a gap between a contact surface of the round blade that comes into contact with the fixed blade and a wall surface facing the contact surface is X, the gap X is preferably at least 1.0 mm.

The cutter device preferably includes a first gear configured to rotate the round blade, the urging portion preferably includes a flange and a spring member, and the round blade is preferably sandwiched between the first gear and the flange.

The cutter device preferably includes a holder configured to hold the round blade, the fixed shaft, the urging portion, and the first gear, an endless belt spanning a pair of pulleys along the first direction, and a rack extending along the first direction. The holder preferably engages with the endless belt and moves in the first direction in accordance with a movement of the endless belt, and the first gear is preferably engaged with the rack via a second gear.

A printing apparatus includes the cutter device described above.

### BRIEF DESCRIPTION OF THE DRAWINGS

FIG. 1 is a perspective view illustrating a configuration of a cutter device according to a first embodiment.

FIG. 2 is an enlarged perspective view illustrating a configuration of a holder.

FIG. 3 is a cross-sectional view taken along a line A-A in FIG. 1.

FIG. 4 is a view describing a force generated in each of portions due to a pressing force of an urging portion.

FIG. 5 is a graph showing a load of a round blade and a cut state of a label sheet.

FIG. 6 is a table showing numerical values of the forces generated in each of the portions.

FIG. 7 is a cross-sectional view illustrating an internal configuration of a printing apparatus according to a second embodiment.

### DESCRIPTION OF EXEMPLARY EMBODIMENTS

### 1. First Embodiment

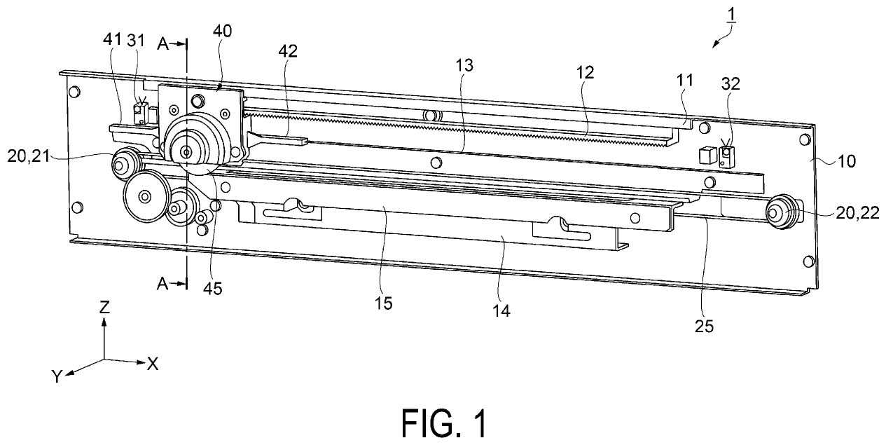

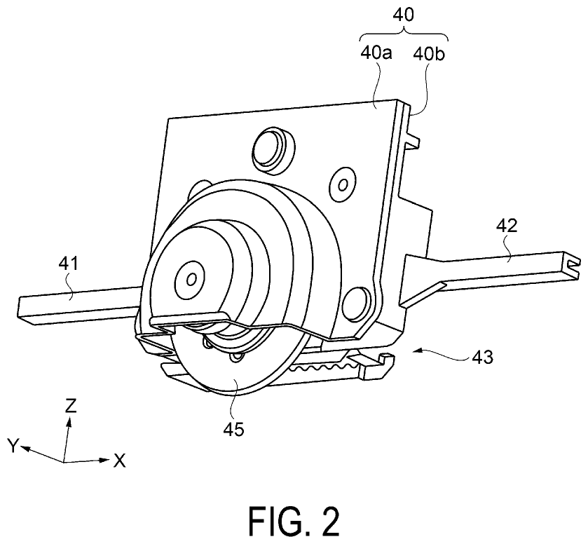

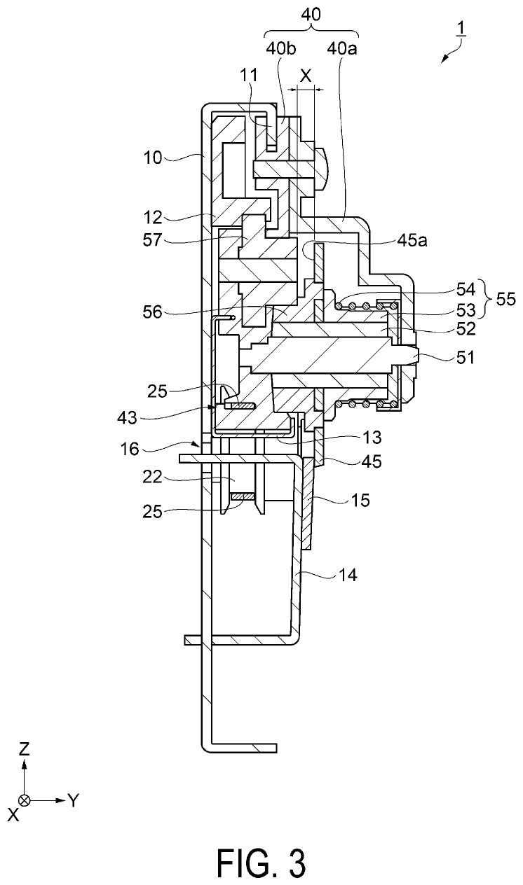

FIG. 1 is a perspective view illustrating a configuration of a cutter device according to a first embodiment. FIG. 2 is a perspective view illustrating a configuration of a holder. FIG. 3 is a cross-sectional view taken along a line A-A in FIG. 1. First, a configuration of a cutter device 1 will be described. Note that, in coordinates indicated in the drawings, both directions along a Z axis are up-down directions and an arrow direction is “up”, both directions along an X axis are left-right directions and an arrow direction is “right”, and both directions along a Y axis are front-rear directions and an arrow direction is “front”. Further, a first direction corresponds to the left-right direction, and a second direction that intersects the first direction corresponds to a rearward direction.

As illustrated in FIG. 1 and FIG. 3, the cutter device 1 includes a frame 10 in which each of portions of the cutter device 1 is configured. The frame 10 has a rectangular shape that is long in the left-right direction, in a plane that includes the X axis and the Z axis. A pair of pulleys 20 is provided along the left-right direction, substantially in the center along the up-down direction of the frame 10. The pair of pulleys 20 includes a first pulley 21 and a second pulley 22. The first pulley 21 is provided at a position near the left end of the frame 10, and the second pulley 22 is provided at a position near the right end of the frame 10. An endless belt 25, one end of which is coupled to the other end of thereof, spans the pair of pulleys 20.

Power to rotate the first pulley 21 is supplied to the first pulley 21 from a motor via a plurality of gears. The endless belt 25 moves in the left and right directions as a result of the rotation of the first pulley 21. A section of the endless belt 25 that spans above the pair of pulleys 20 is engaged with a holder 40 that holds a round blade 45 and the like. The holder 40 moves in the left and right directions in accordance with the movement of the endless belt 25.

The frame 10 includes a fixed blade support portion 14 that supports a fixed blade 15 extending in the left-right direction. The fixed blade support portion 14 is coupled to the frame 10 and protrudes to the front from the frame 10. With the frame 10, the fixed blade support portion 14 forms a hollow quadrangular pillar shape that is long in the left-right direction, and straddles a section of the endless belt 25 that spans below the pair of pulleys 20. The fixed blade 15 has a plate shape that is long in the left-right direction and is fixed to the front surface of the fixed blade support portion 14. The fixed blade 15 has a cutting edge on the upper side thereof.

The frame 10 includes a subframe 13. The subframe 13 is long in the left-right direction and is L-shaped in a side view from the left. The L-shaped side surface of the subframe 13 is coupled to the frame 10. The bottom side of the L shape of the subframe 13 protrudes from the frame 10 so as to face the upper surface of the fixed blade support portion 14, and supports the bottom surface of the holder 40. A paper feed port 16, which is communicated with a gap between the fixed blade support portion 14 and the subframe 13, is provided in the frame 10. For example, a label sheet S printed using the printing apparatus enters the interior of the cutter device 1 from the paper feed port 16, and is transported along the gap between the fixed blade support portion 14 and the subframe 13 onto the fixed blade 15.

The frame 10 includes a guide portion 11 that is engaged with the holder 40 and guides the movement of the holder 40 when the holder 40 moves in the left-right direction. The guide portion 11 is substantially the same length as the fixed blade 15, which is a range of movement of the holder 40 in the left-right direction, and has an inverted L-shape in a side view from the left. The guide portion 11 is a plate-like rail that protrudes to the front from the upper end of the frame 10 and then further bends downward.

The frame 10 includes a rack 12 provided with a plurality of teeth on a long bar-shaped flat plate that extends along the left-right direction. The rack 12 is provided in parallel to and below the guide portion 11, with the teeth facing downward. The rack 12 engages with a second gear 57, and the second gear 57 engages with a first gear 56 that is coupled to the round blade 45. A linear movement that moves the holder 40 in the left-right direction is converted to a rotational force by the second gear 57 engaged with the rack 12, and this rotational force is transmitted to the first gear 56 that rotates the round blade 45. That is, the round blade 45 moves in the left-right direction while rotating with respect to the fixed blade 15.

The frame 10 is provided with a first sensor 31 and a second sensor 32 that detect the position of the round blade 45. The first sensor 31 detects that the round blade 45 is positioned on the first pulley 21 side. The second sensor 32 detects that the round blade 45 is positioned on the second pulley 22 side. A snap-action switch that turns on and off through physical contact, a non-contact proximity sensor using light or magnetism, or the like can be used as the first and second sensors 31 and 32.

The first sensor 31 is provided between the first pulley 21 and an end portion of the guide portion 11 on the first pulley 21 side in the left-right direction, and between the subframe 13 and the rack 12 in the up-down direction.

The second sensor 32 is provided between the second pulley 22 and an end portion of the guide portion 11 on the second pulley 22 side in the left-right direction, and between the subframe 13 and the rack 12 in the up-down direction.

As illustrated in FIG. 2 and FIG. 3, the holder 40 includes a cover 40a and a holder main body 40b. A groove that slidably engages with the guide portion 11 is provided in the upper end of the holder main body 40b. A belt engaging portion 43 that engages with the endless belt 25 is provided at the lower end of the holder main body 40b. The holder 40 is configured to be guided by the guide portion 11, and to be movable in the left-right direction together with the endless belt 25.

The holder 40 includes the first arm 41 protruding from the holder main body 40b toward the left side, and the second arm 42 protruding from the holder main body 40b toward the right side. The first arm 41 and the second arm 42 extend from substantially the center in the up-down direction of the holder 40, along the upper end of the subframe 13.

When the holder 40 is positioned on the first pulley 21 side, the first arm 41 is positioned at a position facing a detector of the first sensor 31. Specifically, by driving the motor that rotates the first pulley 21, the holder 40 moves from the second pulley 22 side toward the first pulley 21 side, together with the endless belt 25. When the holder 40 reaches the first pulley 21 side, the first sensor 31 senses that the first arm 41 is in contact with or in proximity to the detector. As a result, the driving of the motor that rotates the first pulley 21 is stopped, and the holder 40 is positioned on the first pulley 21 side.

When the holder 40 is positioned on the second pulley 22 side, the second arm 42 is positioned at a position facing a detector of the second sensor 32. Specifically, by driving the motor that rotates the first pulley 21, the holder 40 moves from the first pulley 21 side toward the second pulley 22 side, together with the endless belt 25. When the holder 40 reaches the second pulley 22 side, the second sensor 32 senses that the second arm 42 is in contact with or in proximity to the detector. As a result, the driving of the motor that rotates the first pulley 21 is stopped, and the holder 40 is positioned on the second pulley 22 side.

The holder 40 holds the round blade 45, a fixed shaft 51, an urging portion 55, and the first gear 56. The fixed shaft 51 extending along the Y axis is provided between the cover 40a and the holder main body 40b. The first gear 56, the round blade 45, and the urging portion 55 are rotatably supported by the fixed shaft 51 in that order from the holder main body 40b toward the cover 40a. The urging portion 55 presses the round blade 45 in the front-rear direction along the fixed shaft 51. Specifically, the urging portion 55 includes a flange 53 and a spring member 54. The round blade 45 is sandwiched between the first gear 56 and the flange 53. Specifically, the first gear 56 also functions as one flange that is necessary to sandwich the round blade 45 from both sides, and a pair of flanges is configured by the flange 53 and the first gear 56. Further, a bushing 52 for smoothly rotating the first gear 56, the round blade 45, and the urging portion 55 with respect to the fixed shaft 51 is inserted between the fixed shaft 51 and the first gear 56, the round blade 45, and the urging portion 55. In this way, the round blade 45 is rotatably fitted to the fixed shaft 51.

A portion of the round blade 45 is exposed below the holder 40, and the rear surface of the round blade 45 and the front surface of the fixed blade 15 are configured to be able to come into contact. The flange 53 presses the round blade 45 toward the first gear 56, using the spring member 54. As a result, the round blade 45 comes into contact with the fixed blade 15 positioned in the front-rear direction with a predetermined load. Further, the second gear 57 that is engaged with the rack 12 and the first gear 56 is provided between the holder main body 40b and the first gear 56. Because the round blade 45 is coupled so as to be able to rotate together with the first gear 56, the round blade 45 rotates in accordance with movement of the holder 40 in the left-right direction.

As a result of the round blade 45 rotating and moving in the left-right direction in a state in which the round blade 45 is in contact with and pressed against the fixed blade 15, the cutter device 1 cuts the label sheet S that is transported from the paper feed port 16 and that protrudes to the front from the fixed blade 15. Note that the driving of the cutter device 1 is controlled by a control unit provided for an apparatus, such as a printing apparatus, into which the cutter device 1 is incorporated.

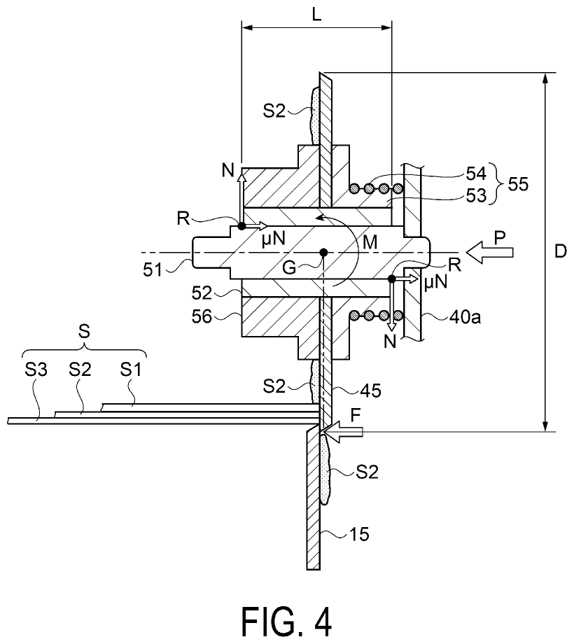

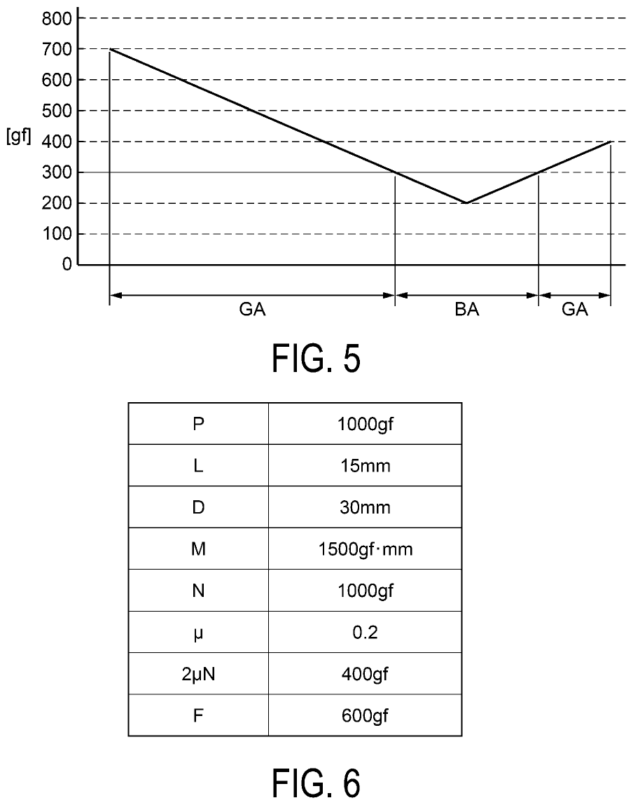

FIG. 4 is a view describing a force generated in each of portions by a pressing force of the urging portion 55. FIG. 5 is a graph showing a load of the round blade 45 and a cut state of the label sheet S. FIG. 6 is a table showing numerical values of the forces generated in each of the portions.

A label S1 on which printing is performed on the front surface thereof, a backing S3, and an adhesive S2 interposed between the label S1 and the mount S3 are layered in the label sheet S. Stainless steel, which has excellent wear resistance, is used as the material of the round blade 45 and the fixing blade 15 that cut the label sheet S, for example, and a silicon coating suitable for cutting the adhesive S2 is applied.

The vertical axis in FIG. 5 shows the load of the round blade 45 pressing against the fixed blade 15. The horizontal axis in FIG. 5 corresponds to a sheet width of the label sheet S. A solid line illustrated in FIG. 5 is a load fluctuation pattern when the round blade 45 is moved from one end of the label sheet S toward the other end thereof while varying the load by which a cutting edge along the outer periphery of the round blade 45 presses the fixed blade 15. In other words, the solid line indicates that the label sheet S was cut while the load of the round blade 45 was decreased from 700 gf to 200 gf at a constant rate and the load was then increased from 200 gf to 400 gf at a constant rate. Regions GA indicate ranges in which the load of the round blade 45 was 300 gf or greater, and the label sheet S was cut well. A region BA indicates a range in which the load of the round blade 45 was less than 300 gf, and the adhesive S2 adhered to the cutting edge of the round blade 45 and the fixed blade 15 caused a cutting defect of the label sheet S. From these results, it can be seen that by setting the load of the round blade 45 pressing the fixing blade 15 to 300 gf or greater, it is possible for the adhesive S2 trying to attach to the cutting edges of the round blade 45 and the fixed blade 15 to be removed from the cutting edges, and the label sheet S can be favorably cut. Note that in the label sheet S used for the cutting, the paper material label S1 has a thickness of approximately 120 μm, the acrylic-based adhesive S2 has a thickness of approximately 15 μm, and the paper material backing S3 has a thickness of approximately 70 μm.

By setting the load of the round blade 45 pressing the fixing blade 15 to 300 gf or greater, the adhesive S2 removed from the cutting edge of the round blade 45 adheres to a contact surface 45a, which is the back surface of the round blade 45 and which comes into contact with the fixed blade 15. As the number of times of cutting the label sheet S increases, some of the adhesive S2 spreads from the outer periphery of the round blade 45 toward the center thereof, and then further accumulates from the contact surface 45a toward wall surfaces facing the contact surface 45a. As illustrated in FIG. 3, a gap of 1.0 mm or greater is provided between the contact surface 45a of the round blade 45 and each of the wall surfaces. In the present embodiment, a gap X between the contact surface 45a and the wall surface of the second gear 57 is the narrowest gap, but the gap X secures a distance of 1.0 mm or greater. When the label sheet S is cut for a long period of time, the adhesive S2 that adheres to the round blade 45 can accumulate in the gap X. In the present embodiment, the large round blade 45 having a diameter D of 20 mm or greater is employed. With the cutter device 1 using the round blade 45 with the diameter D of 20 mm and having the gap X of 1.0 mm, it was possible to cut the 8-inch wide label sheet S more than 50,000 times. Note that an upper limit value of the gap X is determined by an allowable size of the cutter device 1 in the front-rear direction.

The cutter device 1 is configured so that D/L is 2.0 or less, where the diameter of the round blade 45 is D and a length over which the fixed shaft 51 supports the round blade 45 is L. The length over which the round blade 45 is supported is a length including the round blade 45, and the first gear 56 and the flange 53 that sandwich the round blade 45.

FIG. 6 shows the forces generated in each of the portions where the diameter D is 30 mm, and the length L over which the fixed shaft 51 supports the round blade 45 is 15 mm. P is a spring load of the spring member 54 that presses the round blade 45 from the front toward the rear along the fixed shaft 51. F is a load of the round blade 45 pressing against the fixed blade 15. M is a rotational moment at which the round blade 45 attempts to rotate about a point G of the fixed shaft 51 as a result of the round blade 45 pressing the fixing blade 15, and M is obtained using the formula M=P×D/2. N is a normal force acting on the fixed shaft 51 at a point R at which each end of the bushing 52 comes into contact with the fixed shaft 51 by the bushing 52 gouging the fixed shaft 51 due to the rotational moment M of the round blade 45, and N is obtained using the formula N=M/(L/2)/2. μ is a coefficient of friction between the fixed shaft 51 and the bushing 52. μN is a force that obstructs the spring load, and μN is obtained using the formula μN=p×N. The load F by which the round blade 45 actually presses the fixed blade 15 is a value obtained by subtracting a force 2 μN that obstructs the spring load generated at two points from the spring load P, and is obtained using the formula F=P−2×μN.

The fixed blade 15 that is long in the left-right direction undulates slightly in the front-rear direction, and in order to maintain the load F of the round blade 45 moving in the left-right direction with respect to the fixed blade 15 at 300 gf or greater, it is necessary to set the load F of the round blade 45 to 600 gf. As shown in FIG. 6, in the cutter device 1 in which D/L is 2.0, in order to obtain the load F of the round blade 45 of 600 gf, it is necessary to use the spring member 54 with the spring load P of 1000 gf. The spring member 54 with the spring load P of 1000 gf can be realized by compressing a coil spring of approximately 10 mm in length, and can be mounted on the length L of 15 mm over which the fixed shaft 51 supports the round blade 45.

When D/L is set to 2.0 or greater, it is necessary to use the spring member 54 having the large spring load P. If the spring load P of the spring member 54 is made too large, the normal force N, which is the gouging force bearing on the fixed shaft 51, increases, and the rotation of the round blade 45 may be inhibited, resulting in the cutting defect of the label sheet S. Further, in order to increase the spring load P, it is necessary to employ a long coil spring, and in contrast, the size of the cutter device 1 in the front-rear direction may become larger. Further, a load of a motor for moving the round blade 45 in the left-right direction increases, and the lifespan of the motor may become shorter, or the size in the front-rear direction of the cutter device 1 may increase as a result of employing a larger motor. In other words, the upper limit of 2.0 for D/L is a value at which it is possible to realize the thin cutter device 1 provided with the large round blade 45 and capable of favorably cutting the label sheet S. Note that the lower limit for D/L is determined by the size of the round blade 45 used and the allowable size of the cutter device 1 in the front-rear direction.

According to the present embodiment, the following effects can be obtained.

In the cutter device 1, in order to keep the load F of the round blade 45 pressing the fixed blade 15 at 300 gf or greater, at which the label sheet S is favorably cut, the load F is set to 600 gf. Since the cutter device 1 is configured such that D/L is 2.0 where the diameter of the round blade 45 is D and the length over which the fixed shaft 51 supports the round blade 45 is L, it is possible to realize the load F of the round blade 45 of 600 gf using the spring member 54 having the spring load P of 1000 gf or less. As a result, the normal force N, which is the gouging force that bears on the fixing shaft 51, is suppressed, and it is thus possible to favorably cut the label sheet S without the rotation of the round blade 45 being obstructed.

Further, since the large round blade 45 having the diameter of 20 mm or greater is employed in the cutter device 1, an area over which the adhesive S2 is caused to accumulate on the round blade 45 is increased, and the lifespan of the cutter device 1 can be increased.

Accordingly, the cutter device 1 can be obtained that achieves both the extended lifespan of the cutter device 1 and the suppression of cutting defects.

In the cutter device 1, the gap X between the contact surface 45a of the round blade 45 and the wall surface of the second gear 57 is 1.0 mm or greater. As a result, when the label sheet S is cut for the long period of time, a volume can be secured for the adhesive S2 that attaches to the round blade 45 to accumulate, and thus, the lifespan of the cutter device 1 can be increased.

The round blade 45 of the cutter device 1 is sandwiched between the first gear 56 and the flange 53 and is rotatably fitted to the fixed shaft 51 via the bushing 52. Since the first gear 56 also serves as the flange forming the pair of flanges with the flange 53 in order to sandwich the round blade 45 from both sides, a number of parts can be reduced and the cutter device 1 can be made thinner.

The cutter device 1 includes the rack 12, which is coupled to the round blade 45 via the first and second gears 56 and 57. The round blade 45 is forced to rotate by the rotational force obtained by the second gear 57 engaged with the rack 12 converting the linear movement that moves the holder 40, and thus, the round blade 45 can favorably cut the label sheet S.

### 2. Second Embodiment

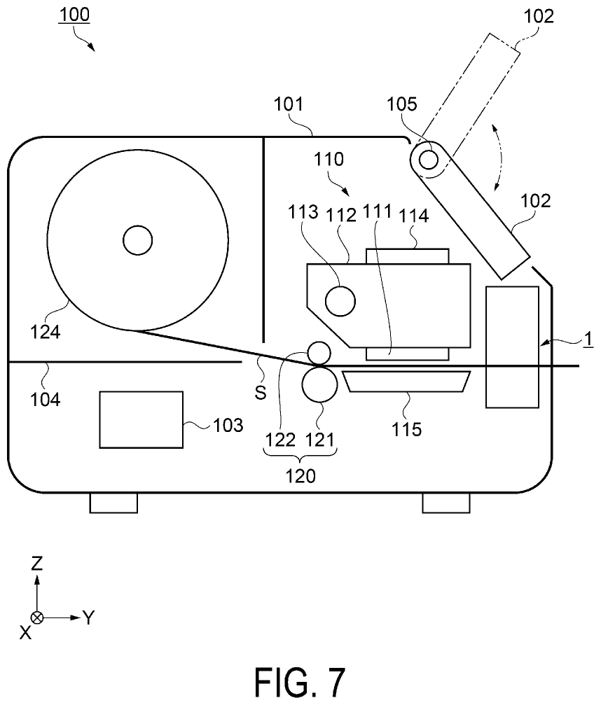

FIG. 7 is a cross-sectional view illustrating an internal configuration of a printing apparatus according to a second embodiment. The configuration of a printing apparatus 100 provided with the cutter device 1 described in the first embodiment will be described.

The printing apparatus 100 is configured by a housing 101 and a panel 102 capable of opening and closing part of the interior of the housing 101 with respect to the outside. The panel 102 is coupled to the housing 101 via a shaft 105 supported by the housing 101 and is configured to open and close toward the front with respect to the housing 101, by pivoting about the shaft 105. The panel 102 is a liquid crystal screen provided with a touch panel, and is configured to display visual information to a user and receive input operations from the user, for example. Note that a specific mechanism for opening and closing the panel 102 with respect to the housing 101 is not particularly limited. The cutter device 1 is built into the front of the interior of the printing apparatus 100.

The printing apparatus 100 includes a control unit 103, a housing unit 104, a printing unit 110, a transport unit 120, and the like.

The control unit 103 is provided with a central processing unit (CPU) that is a processor, a memory, and the like. The control unit 103 generates recording data for recording on the label sheet S, as a result of the processor executing arithmetic processing in accordance with a program stored in the memory. As a result of the control unit 103 controlling each unit of the printing apparatus 100 on the basis of the recording data, an image or the like is recorded on the label sheet S. The processor is not limited to the single CPU, and may be configured to perform processing using a plurality of the CPUs, or a hardware circuit such as an application specific integrated circuit (ASIC), or may have a configuration in which the CPU and the hardware circuit perform the processing in concert with each other.

The housing unit 104 is provided to the rear inside the housing 101, and forms a space for housing the label sheet S. A roll paper main body 124, around which the long label sheet S is wound in a roll shape, is housed in the housing unit 104. The printing apparatus 100 is configured to allow the roll paper main body 124 to be fitted into the housing unit 104 from a lid (not illustrated), by opening the lid. Recording is possible on the label sheet S using a recording agent, such as ink, toner, or the like, and the label sheet S may be any material that can be cut by the cutter device 1.

The printing unit 110 is provided with a recording head 111, a carriage 112, a platen 115, and the like.

The platen 115 supports the label sheet S that is wound out from the roll paper main body 124 and transported to a position facing the recording head 111 along the Y axis, which is a transport direction. The recording head 111 is disposed above the platen 115.

The recording head 111 includes a plurality of nozzles capable of discharging ink, and performs recording using an ink-jet method. The recording head 111 receives a supply of the ink from an ink cartridge 114. The recording head 111 and the ink cartridge 114 are mounted on the carriage 112. The carriage 112 is supported by a guide rail 113 disposed along the X axis, and is configured to be reciprocally movable in both directions along the X axis, which is a main scanning direction. The recording head 111 performs the recording on the label sheet S by discharging the ink from the nozzles as the carriage 112 moves. The printing apparatus 100 is configured to allow replacement of the ink cartridge 114 and maintenance of the printing unit 110 by opening the panel 102. Note that, in the present embodiment, as the recording head 111, a serial head type is exemplified in which a head mounted on the carriage 112 discharges the ink while reciprocally moving in the main scanning direction, but the recording head 111 may be a line head type in which recording heads are arranged and fixed extending in the left-right direction along the X axis, that is, in a width direction of the label sheet S.

The transport unit 120 is provided with rollers 121 and 122.

The rollers 121 and 122 are a pair of rollers disposed upstream of the platen 115 in the transport direction. The rollers 121 and 122 transport the label sheet S by rotating while sandwiching the label sheet S therebetween. The roller 121 is a drive roller that rotates as a result of being powered by a motor. The roller 122 is a driven roller that rotates in accordance with the rotation of the drive roller. Note that a configuration may be adopted in which a plurality of roller pairs are provided for transporting the label sheet S.

The cutter device 1 that cuts the label sheet S that is printed by the printing unit 110 and transported in the transport direction is provided downstream of the platen 115 in the transport direction.

Note that the printing apparatus 100 may be an apparatus configured to perform recording using a method that is not the ink-jet method. For example, in place of the recording head 111, the printing apparatus 100 may be provided with a printer engine that performs recording by depositing toner onto the label sheet S using an electrophotographic method. Further, the printing apparatus 100 may be a thermal printer.

According to the present embodiment, the following effects can be obtained.

Since the printing apparatus 100 includes the cutter device 1 having a long lifespan, reliability of the printing apparatus 100 is improved.

Contents derived from the embodiments will be described below.

A cutter device includes a fixed blade extending in a first direction, a fixed shaft extending in a second direction intersecting the first direction, a round blade rotatably supported by the fixed shaft and configured to come into contact with the fixed blade positioned in the second direction and to move in the first direction while rotating, and an urging portion configured to press the round blade in the second direction along the fixed shaft. A load of the round blade pressing the fixed blade is at least 300 gf, a diameter of the round blade is at least 20 mm, and D/L is not greater than 2.0, where the diameter of the round blade is D and a length over which the fixed shaft supports the round blade is L.

According to this configuration, the cutter device presses a cutting edge of the round blade against the fixed blade with a load of at least 300 gf, and it is thus possible to favorably cut a label paper including adhesive. A gouging force that is generated when the urging portion presses the round blade along the fixed shaft and the cutting edge of the round blade comes into contact with the fixed blade and that bears on the fixed shaft is proportional to a pressing force pressing the round blade along the fixed shaft, and to the diameter D of the round blade, and is inversely proportional to the fixed shaft length L. Since D/L is set to be not more than 2.0, the pressing force of the urging portion that suppresses the gouging force can press the round blade against the fixed blade with the load of at least 300 gf. Since the large-diameter round blade having a diameter of at least 20 mm is employed in the cutter device, an area over which the adhesive is caused to accumulate on the round blade is increased, and the lifespan of the cutter device can thus be increased. Accordingly, the cutter device can be obtained that achieves both an extended lifespan of the cutter device and a suppression of cutting defects.

In the cutter device described above, where a gap between a contact surface of the round blade that comes into contact with the fixed blade and a wall surface facing the contact surface is X, the gap X is preferably at least 1.0 mm.

According to this configuration, it is possible to further increase the lifespan of the cutter device because a volume in which the adhesive attached to the round blade is accumulated is increased.

The cutter device preferably includes a first gear configured to rotate the round blade, the urging portion preferably includes a flange and a spring member, and the round blade is preferably sandwiched between the first gear and the flange.

According to this configuration, the round blade is sandwiched between the first gear and the flange of the urging portion. The first gear also functions as one of the flanges forming a pair of flanges necessary to sandwich the round blade 45 from both sides, and thus, a number of parts can be reduced and the cutter device can be made thinner.

The cutter device preferably includes a holder configured to hold the round blade, the fixed shaft, the urging portion, and the first gear, an endless belt spanning a pair of pulleys along the first direction, and a rack extending along the first direction. The holder preferably engages with the endless belt and moves in the first direction in accordance with a movement of the endless belt, and the first gear is preferably engaged with the rack via a second gear.

According to this configuration, the round blade is forced to rotate by a rotational force obtained by the second gear engaged with the rack converting a linear movement that moves the holder, and thus, the round blade can favorably cut the label sheet.

A printing apparatus includes the cutter device described above.

According to this configuration, since the printing apparatus includes the cutter device having the long lifespan, reliability of the printing apparatus is improved.

What is claimed is:

1. A cutter device comprising:
a fixed blade extending in a first direction;
a fixed shaft extending in a second direction intersecting the first direction;
a round blade rotatably supported by the fixed shaft, and configured to come into contact with the fixed blade positioned in the second direction and to move in the first direction while rotating; and
an urging portion configured to press the round blade in the second direction along the fixed shaft, wherein
a load of the round blade pressing the fixed blade is at least 300 gf,
a diameter of the round blade is at least 20 mm, and
D/L is not greater than 2.0, where the diameter of the round blade is D and a length over which the fixed shaft supports the round blade is L.

2. The cutter device according to claim 1, wherein
where a gap between a contact surface of the round blade that comes into contact with the fixed blade and a wall surface facing the contact surface is X, the gap X is at least 1.0 mm.

3. The cutter device according to claim 1, comprising
a first gear configured to rotate the round blade, wherein
the urging portion includes a flange and a spring member, and
the round blade is sandwiched between the first gear and the flange.

4. The cutter device according to claim 3, comprising:
a holder configured to hold the round blade, the fixed shaft, the urging portion and the first gear;
an endless belt spanning a pair of pulleys along the first direction; and
a rack extending along the first direction, wherein
the holder engages with the endless belt and moves in the first direction in accordance with a movement of the endless belt, and
the first gear is engaged with the rack via a second gear.

5. A printing apparatus comprising
the cutter device according to claim 1.
